(19) United States
(12) Patent Application Publication
(10) Pub. No.: US 2026/0066625 A1
(43) Pub. Date: Mar. 5, 2026

(54) MOBILE MULTI-VOLTAGE POWER DISTRIBUTION SYSTEM

(71) Applicant: STEWART & STEVENSON LLC, Houston, TX (US)

(72) Inventors: Mike WARHUS, Houston, TX (US); Brian SHARP, Houston, TX (US); Charles EKE CHUKWU, Houston, TX (US)

(21) Appl. No.: 19/298,669

(22) Filed: Aug. 13, 2025

Related U.S. Application Data
(60) Provisional application No. 63/687,594, filed on Aug. 27, 2024.

(51) Int. Cl. H02B 1/52; H02B 1/14; H02B 1/24; H02B 1/30; H02B 1/34

(52) U.S. Cl. CPC H02B 1/52; H02B 1/14; H02B 1/24; H02B 1/308; H02B 1/34

(57) ABSTRACT

A mobile multi-voltage power distribution system may include a trailer and a skid connected to or integrated with the trailer. The system may also include incoming power connections, the incoming power connections in mechanical connection with the skid. Further, the system may include outgoing feeder connections, the outgoing feeder connections in mechanical connection with the skid and medium voltage switchgear. The medium voltage switchgear may be coupled to the skid and in electrical connection with the incoming power connections. The medium voltage switchgear is in electrical connection with a transformer and at least one of the medium voltage switchgear is connected to one of the outgoing feeder connections. The transformer is coupled to the skid. The system further includes a low voltage switchgear, the low voltage switchgear coupled to the skid and electrically coupled to the transformer and to at least one of the outgoing feeder connections.

### CROSS-REFERENCE TO RELATED APPLICATIONS

This application is a nonprovisional application which claims priority from U.S. provisional application No. 63/687,594, filed Aug. 27, 2024, which is incorporated by reference herein in its entirety

### TECHNICAL FIELD/FIELD OF THE DISCLOSURE

The present disclosure relates generally to a mobile power distribution system.

### BACKGROUND OF THE DISCLOSURE

Electrical power generation, distribution, and storage may be especially important when operating at remote or otherwise unimproved locations without access to or without consistent access to a traditional electrical grid. Industrial equipment, for example, that is used for drilling and fracing operations may use high voltage and low voltage equipment that are fed from electric power generation equipment

### SUMMARY

The present disclosure provides for a mobile multi-voltage power distribution system. The mobile multi-voltage power distribution system may include a skid and incoming power connections. The incoming power connections may be in mechanical connection with the skid. The mobile multi-voltage power distribution system may also include outgoing feeder connections where the outgoing feeder connections are in mechanical connection with the skid. The multi-voltage power distribution system may also include a medium voltage switchgear, the medium voltage switchgear coupled to the skid in electrical connection with the incoming power connections, and at least one of the outgoing feeder connections. In addition, the multi-voltage power distribution system may include a transformer, the transformer in electrical connection with the medium voltage switchgear and coupled to the skid and a low voltage switchgear, the low voltage switchgear coupled to the skid and electrically coupled to the transformer and to at least one of the outgoing feeder connections.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1A depicts a first side view of a mobile multi-voltage power distribution system consistent with at least one embodiment of the present disclosure.

FIG. 1B depicts a top-down view of a mobile multi-voltage power distribution system consistent with at least one embodiment of the present disclosure.

FIG. 1C depicts a reversed second side view of a mobile multi-voltage power distribution system consistent with at least one embodiment of the present disclosure.

FIG. 2A depicts an isometric view of a mobile multi-voltage power distribution system with enclosure removed consistent with at least one embodiment of the present disclosure.

FIG. 2B is a view of medium voltage switchgear consistent with certain embodiments of the present disclosure.

FIG. 3A depicts the first side view of the mobile multi-voltage power distribution system of FIG. 1A.

FIG. 3B depicts an anisometric view of the incoming power connections of FIG. 3A.

FIG. 3C depicts an isometric view of an electrical connection port used for the incoming power connections consistent with certain embodiments of the present disclosure.

FIG. 4A depicts a second side view of a mobile multi-voltage power distribution system consistent with at least one embodiment of the present disclosure.

FIG. 4B depicts outgoing feeder connections of FIG. 4A.

FIG. 4C depicts an isometric view of an electrical connection port used for the outgoing feeder connections consistent with certain embodiments of the present disclosure.

FIG. 4D depicts an isometric view of an electrical connection port used for the outgoing feeder connections consistent with certain embodiments of the present disclosure.

FIG. 5 is a line drawing of the medium voltage electrical system consistent with certain embodiments of the present disclosure.

FIG. 6 is a line drawing of the low voltage electrical system consistent with certain embodiments of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

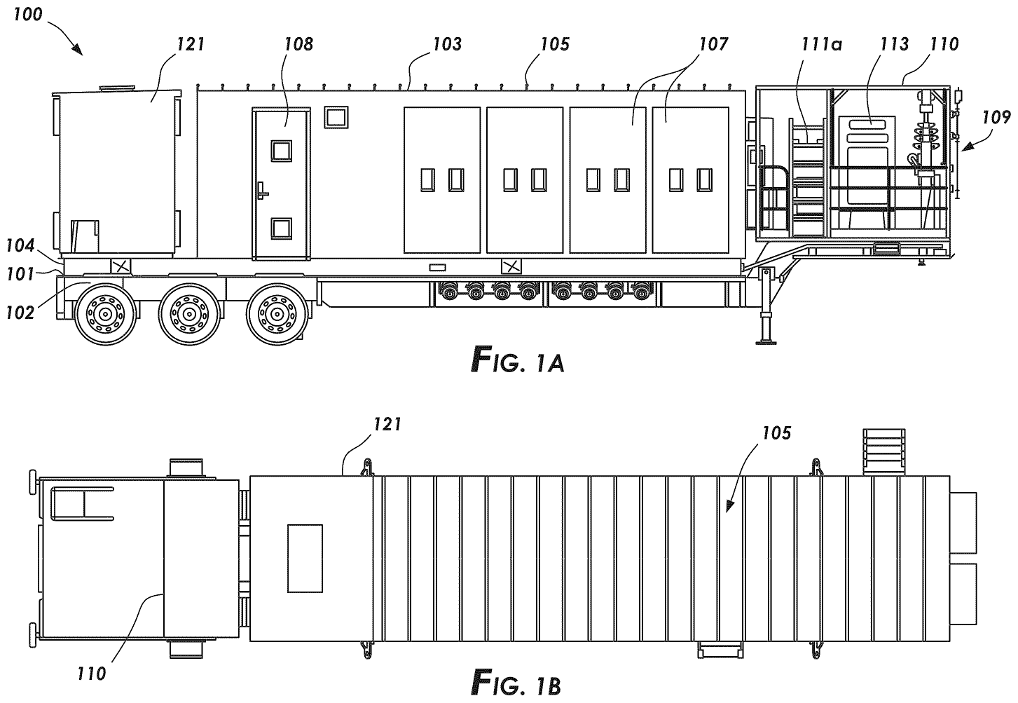

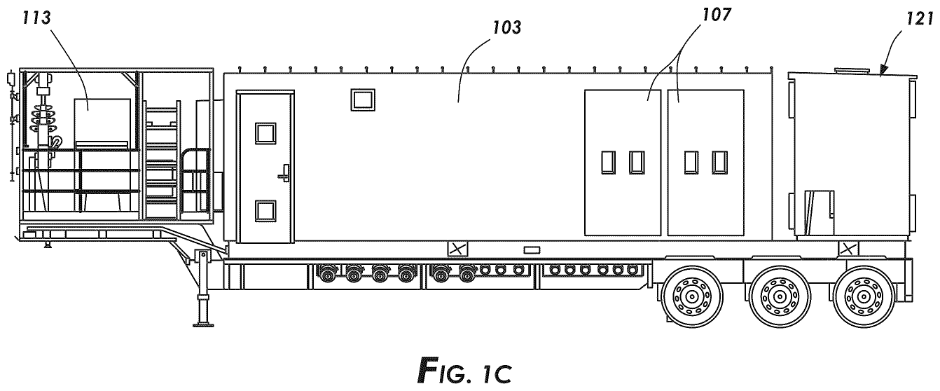

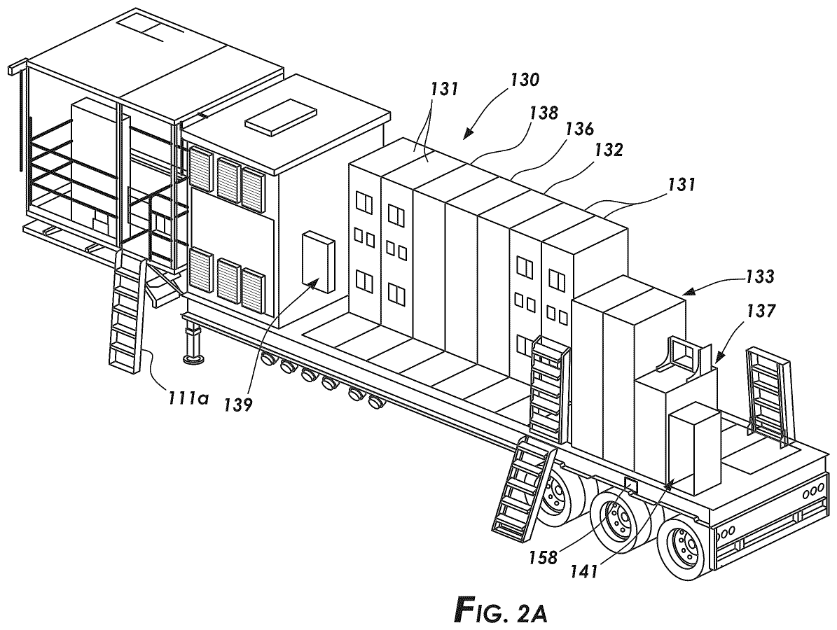

FIG. 1A depicts a side view of mobile multi-voltage power distribution system 100 consistent with at least one embodiment of the present disclosure. Mobile multi-voltage power distribution system 100 may include skid 101. Skid 101 may be made of steel or other appropriate material. Skid 101 may provide a base and support for mobile multi-voltage power distribution system 100. In some embodiments, skid 101 may include equipment used to transport mobile multi-voltage power distribution system 100 by truck including, for example and without limitation, winch points, roll bars, or other features. In other embodiments, skid 101 may be connected to or integrated with trailer 102 for transportation of mobile multi-voltage power distribution system 100.

As shown in FIGS. 1A-1C, in some embodiments, mobile multi-voltage power distribution system 100 may include outer enclosure 103. Outer enclosure 103 may be mechanically coupled to skid 101 and may house some of the components of mobile multi-voltage power distribution system 100. Outer enclosure 103 may provide environmental protection to the components and protection from shock and arcing to personnel in the vicinity of mobile multi-voltage power distribution system 100. In some embodiments, outer enclosure 103 may include roof 105. Skid 101 may be a singular piece or may be composed of separate pieces. In some embodiments, outer enclosure 103, roof 105, or both may include louvres for ventilation requirements such as, for example and without limitation to account for heating of equipment within outer enclosure 103. In some embodiments, such louvres may be actuatable by motors or other actuation devices. In some embodiments, outer enclosure 103 may be removable from the rest of mobile multi-voltage power distribution system 100 by, for example and without limitation, lifting with an overhead crane system.

In some embodiments, outer enclosure 103 may include one or more removable access panels 107. Removable access panels 107 may be positioned for maintenance and serviceability to rear sections of breakers, cabling, and other electrical components, positioned within outer enclosure 103. Removable access panels 107 may allow access to the battery or batteries and any associated electronics from outside of mobile multi-voltage power distribution system 100. In some embodiments, removable access panels 107 may include a seal positioned around the perimeter thereof to reduce or prevent the ingress of dust or water from the surrounding environment into the interior of outer enclosure 103. Outer enclosure 103 may also include service access door 108 for maintenance and serviceability for the equipment within outer enclosure 103.

In some embodiments, thermal insulation may be applied to interior surfaces of outer enclosure 103 which may, for example and without limitation, help maintain interior climate conditions and mitigate environmental fluctuations outside the enclosure.

In certain embodiments, outer enclosure 103 may include HVAC systems for enclosure cooling, heating, and controlling the humidity of the equipment inside outer enclosure 103. In some of these embodiments, outer enclosure 103 may include redundant HVAC systems.

In certain embodiments, work platform 109 may be positioned on trailer 102 outside of outside enclosure 103. In some embodiments, work platform 109 may include work platform roof 110. Work platform 109 may be enclosed, or in the examples shown in FIGS. 1A and 1C, open. Stowable ladder 111a may be attached to trailer 102 or to work platform 109 to assist personnel in reaching work platform 109. Stowable ladder 111a may be positioned in a down position for entry by personnel and in an up position when stored.

Work platform 109 may further include human machine interface (HMI) 113 for input and output of data (by means of switches, screens, keys, or other data entry and display mechanisms) and provides for remote operation to reduce harm and electrical risk to personnel. In certain embodiments, HMI 113 may be a computer or a control system. HMI 113 may be in data connection with equipment positioned on trailer 102.

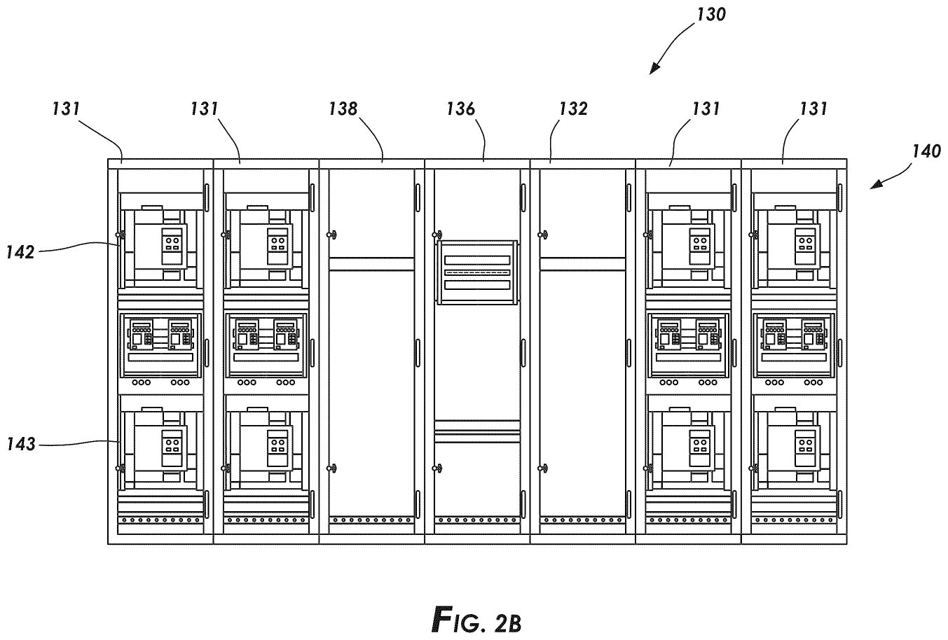

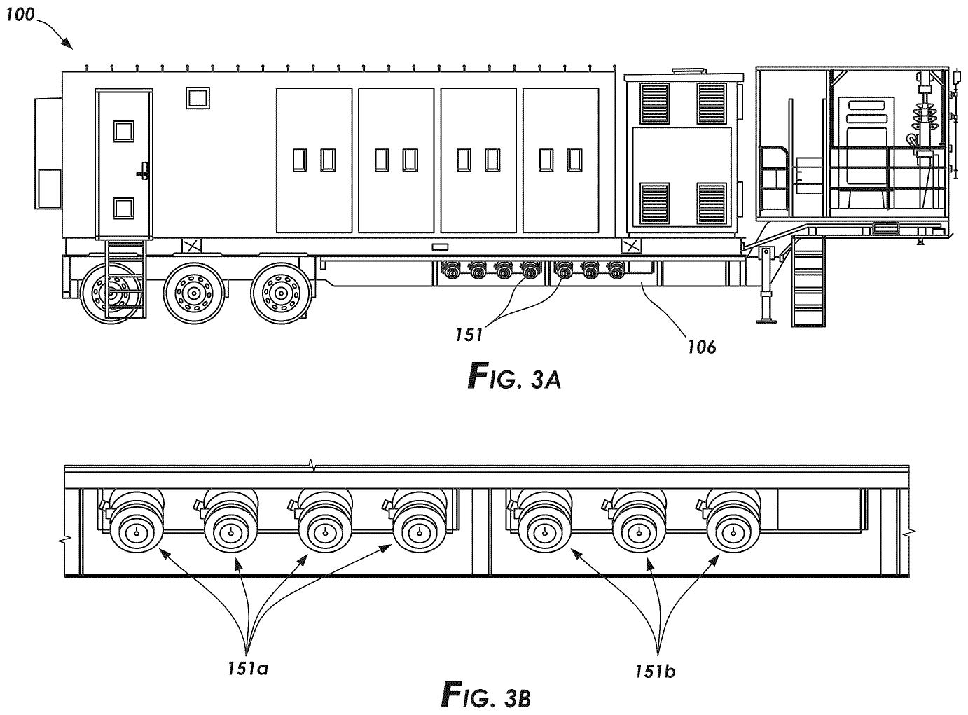

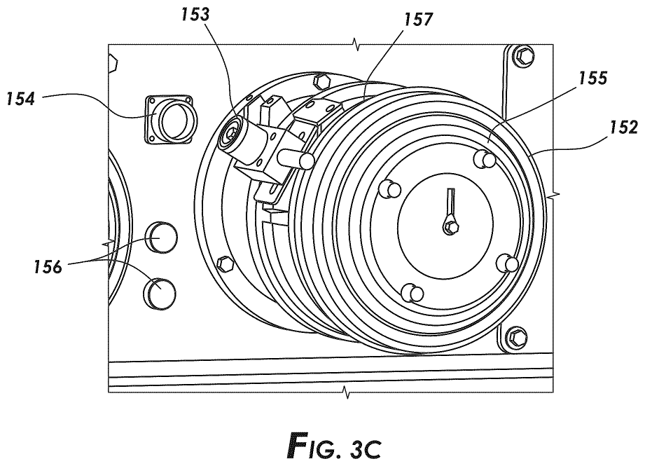

Mobile multi-voltage power distribution system 100 may also include incoming power connections 151 as shown in FIGS. 3A and 3B. Mobile multi-voltage power distribution system 100 may have any number of incoming power connections 151, for example between 1 and 20. Incoming power connections 151 may be in electrical connection with medium voltage switchgear 130, such as depicted in FIG. 2A. In certain embodiments, medium voltage that is supplied to medium voltage switchgear is between 1 KV and 35 KV. Incoming power connections 151 may be positioned on underside 106 of trailer 102 and mechanically coupled to skid 101. In certain embodiments, as shown in FIG. 3B, incoming power connections 151 may be divided into incoming main power connections 151a and incoming utility power connections 151b.

Incoming power connections 151 may be in electrical connection with one or more generators or line power. In certain embodiments, incoming power connections 151 may include interlock 152 as shown in FIG. 3C, which may include a mechanical interlock and an electrical interlock. Interlock 152 may include interlock key cylinder 153, multi-pin interlock cable port 154, main cable connection 157, connection cap 155, and indicator lights 156. In mechanical interlock operation, before incoming main power connection cables, such as from generators, and incoming utility power connector cables, such as from a power grid, may be connected to main cable connection 157, a key must be inserted into interlock key cylinder 153 on connection cap 155 and the key turned. Once the key has been turned, connection cap 155 may be removed and main power connection cable or the utility power connector cables may be inserted into incoming power connection 151. Once the cable has been inserted, the key may be used to re-engage interlock key cylinder 153 and the key then removed to lock the cable in place. A key may be kept in the breaker to which the particular incoming power connection 151 corresponds. Once the key has been used to lock the cable in place, the key may be returned to the breaker. In electrical interlock operation, once the incoming power cable has been connected, as described above, a multi-pin auxiliary cable to the incoming power cable may be plugged into multi-pin interlock cable port 154. The connection of the multi-pin auxiliary cable to multi-pin interlock cable port 154 indicates that connected equipment is wired properly before the corresponding breaker may be engaged. Once the mechanical and electrical interlock procedures have been completed, the corresponding breaker may be engaged and indicator lights 156 may change, such as from green to red, with red meaning that the breaker is engaged and green meaning that the breaker is open.

As shown in FIG. 2A, mobile multi-voltage power distribution system 100 may also include medium voltage switchgear 130 allowing for various input power sources including, but not limited to reciprocating generator, turbine generator and utility power, for example. In some embodiments, medium voltage switchgear 130 may be 13.8 kV. Medium voltage switchgear 130 may be mounted on skid 101 and positioned within outer enclosure 103.

As shown in FIGS. 2A and 2B, in certain embodiments, medium voltage switchgear 130 may include: dual stack switchgear cabinets 131, main switchgear cabinet 132, which is a cabinet with a breaker for incoming main power, utility switchgear cabinet 138, which is a cabinet with a breaker for incoming utility power, and Control Power Transformer (CPT) cabinet 136 may be arranged as shown in FIGS. 2A and 2B. Dual stack switchgear cabinets 131 are switchgear where two breakers are stacked vertically in each cabinet, along with electrical controls for the breakers. For instance, as shown in FIG. 2B, dual stack switchgear cabinets 131 may include upper breaker 142 and lower breaker 143. While shown as having four dual stack switchgear cabinets 131 in FIGS. 2A and 2B, the disclosure is not so limited and, in certain embodiments, the number of dual stack switchgear cabinets 131 may only be limited by the amount of power transferred through incoming power connections 151 or the bus rating, as described below. Additional dual stack switchgear cabinets 131 may allow for additional power supplies from medium voltage switchgear 130. Utility switchgear cabinet 138 may allow a utility grid connection to supply dual stack switchgear cabinets 131 with 13800V power. Main switchgear cabinet 132 may allow main power generators to supply dual stack switchgear cabinets 131 with 13800V power.

In certain embodiments, power may be provided to mobile multi-voltage power distribution system 100 from utility power, main incoming power, or both. In certain embodiments, when both utility power and main incoming power are used, utility power may be supplied first such that generators supplying main incoming power may be synchronized with utility power.

Medium voltage switchgear 130 may be arranged in medium switchgear row 140. The order of certain of the elements in medium switchgear row 140 includes advantages over other arrangements. For example, by having balanced dual stack switchgear cabinets 131 at the ends of medium switchgear row 140, power may be moved right and left, reducing heat load on the components of medium switchgear row 140.

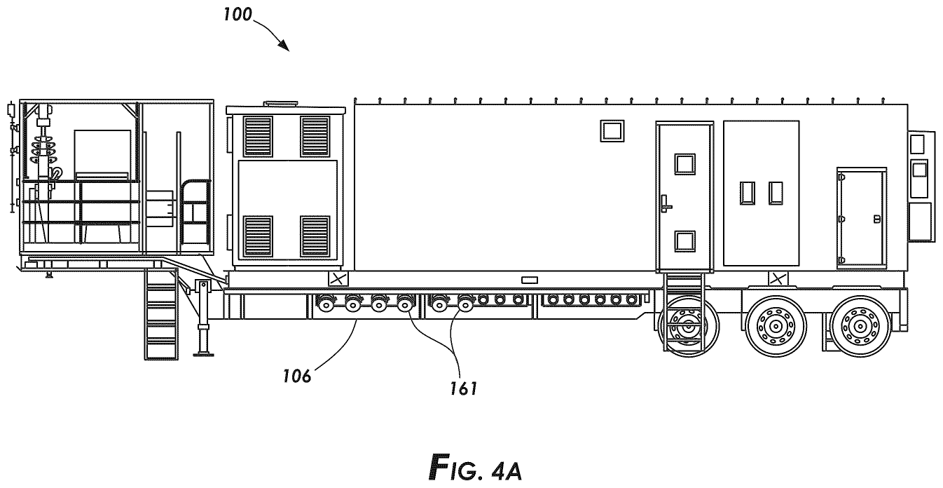

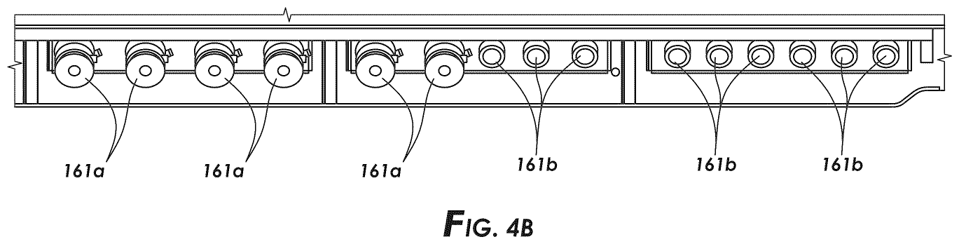

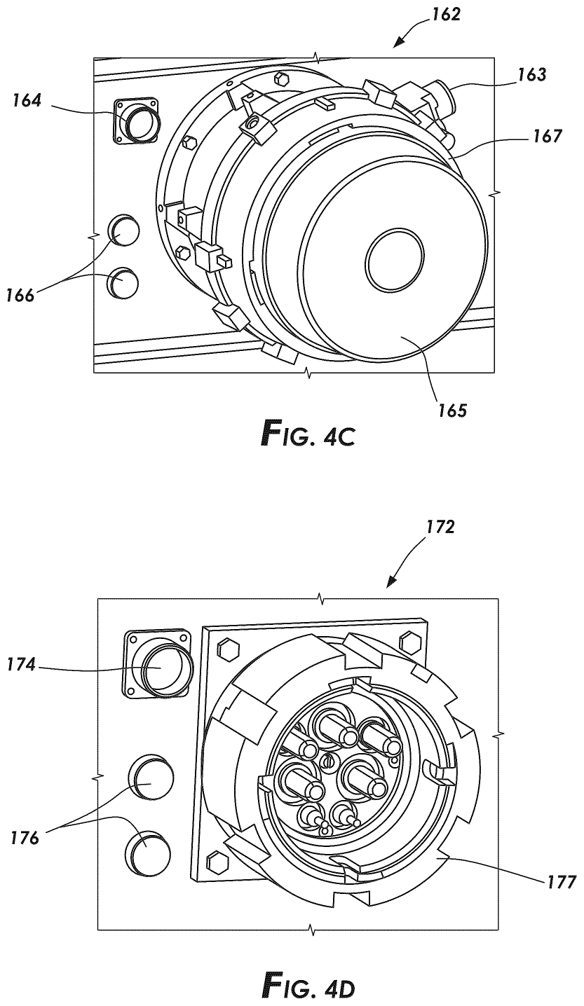

In some embodiments, certain of breakers 142, 143 provide power to outgoing feeder connection 161, which is shown in FIG. 4A. In these embodiments, at least one of breakers 142, 143 may supply power to transformer 121.

Transformer 121 may be mounted on skid 101, as shown in FIGS. 1A-C and FIG. 2. As shown in FIG. 1A, transformer 121 may be at rear end 104 of trailer 102. In other embodiments, transformer 121 may be mounted on skid 101 adjacent to work platform 109, as shown in FIG. 1B. While transformer 121 may be of any rating, in some embodiments, transformer 121 is a 3000 kVa transformer. In some embodiments, transformer 121 may include a primary winding to accommodate 13.8k as primary voltage from at least one of dual stack switchgear cabinets 131, a secondary winding to accommodate 480V as secondary voltage, and a third winding to accommodate 208/240/120V. Transformer 121 may include a cooling system such as fans to mobilize ambient air. 208/240 power may be used to power auxiliary electrical equipment within the switchgear, such as HVAC, fans, and any batteries. The 480V power may be used to supply power to low voltage switchgear 133.

As shown in FIGS. 2A and 6, mobile multi-voltage power distribution system 100 may also include low voltage switchgear 133 in electrical connection with transformer 121. Low voltage switchgear 133 operates at a lower voltage than medium voltage switchgear 130. In some embodiments, low voltage switchgear 133 may be 0-1000 VAC, or 480V. Low voltage switchgear 133 may be mounted on skid 101 and within outer enclosure 103. Low voltage switchgear 133 includes breakers to allow for the distribution of low voltage power to outgoing feeder connections 161.

As shown in FIG. 2A, in some embodiments, mobile multi-voltage power distribution system 100 may also include battery 137 adapted to switch among alternate power sources including, but not limited to a local supply from step down transformer and other input in the range, for example, of 208V-240V that provides DC power for actuation of circuit breakers within low voltage switchgear 133 and medium voltage switchgear 130. Battery 137 may be mounted on skid 101 and within outer enclosure 103. Battery 137 may supply power to control systems, lighting, and HVAC. In certain embodiments, battery 137 may be electrically connected to external port 158. External port 158 allows for an external generator to be in electrical connection with battery 137 so that a dead battery can be charged.

In addition, mobile multi-voltage power distribution system 100 may also include panel board 139. Panel board 139 may operate 120V/208V, 240V circuits, such as, for example, heating, lighting, cooling, charging and external outlets. Panel board 139 may be mounted on skid 101 and within outer enclosure 103.

In some embodiments, mobile multi-voltage power distribution system 100 may also include server rack 141 for remote communications or communication with a data van. Server rack 141 may be mounted on skid 101 and within outer enclosure 103. In certain embodiments, server rack 141 may include an uninterruptible power supply (UPS).

As shown in FIGS. 4A-D, mobile multi-voltage power distribution system 100 may also include outgoing feeder connections 161. Outgoing feeder connections 161 may be positioned on the underside 106 of trailer 102 and in mechanical connection to skid 101. Mobile multi-voltage power distribution system 100 may have any number of outgoing feeder connections 161, such as between 1 and 20. Certain outgoing feeder connections 161 may be in electrical connection with medium voltage switchgear 130 and other outgoing feeder connections 161 may be in low voltage switchgear 133. For example, as shown in FIG. 4B, medium voltage outgoing feeder connections 161a may be in electrical connection with medium voltage switchgear 130, whereas low voltage outgoing feeder connections 161b may be in electrical connection with low voltage switchgear 133.

Outgoing feeder connections 161 may be in electrical connection with one or more users of electrical power. In certain embodiments, these users may include such users as blenders, utility loads, and any load that is operated at between 13800V and 480V power. In certain embodiments, outgoing feeder connections 161 may be equipped with feeder interlocks 162, for medium voltage outgoing feeder connections 161a and low voltage feeder interlocks 172 for low voltage outgoing feeder connections 161b as shown in FIGS. 4C and 4D, respectively, which may be both mechanical and electrical interlocks. Feeder interlock 162 may include medium voltage interlock key cylinder 163, medium voltage multi-pin interlock cable port 164, medium voltage cable connection 167, medium voltage connection cap 165, and medium voltage indicator lights 166. In mechanical interlock operation, before outgoing medium voltage feeder connection cables, such to power-using equipment, may be connected to medium voltage cable connection, a key must be inserted into medium voltage interlock key cylinder 163 on medium voltage connection cap 165 and the key turned. Once the key has been turned, medium voltage connection cap 165 may be removed and the medium voltage cables may be inserted into outgoing feeder connection 161. Once the cable has been inserted, the key may be used to re-engage medium voltage interlock key cylinder 163 and the key then removed to lock the cable in place. A key may be kept in the breaker to which the particular outgoing feeder connection 161 corresponds. Once the key has been used to lock the cable in place, the key may be returned to the breaker. In electrical interlock operation, once the outgoing feeder cable has been connected, as described above, a multi-pin auxiliary cable to the outgoing feeder cable may be plugged into medium voltage multi-pin interlock cable port 164. The connection of the multi-pin auxiliary cable to medium voltage multi-pin interlock cable port 164 indicates that connected equipment is wired properly before the corresponding breaker may be engaged. Once the mechanical and electrical interlock procedures have been completed, the corresponding breaker may be engaged and medium voltage indicator lights 166 may change, such as from green to red, with red meaning that the breaker is engaged and green meaning that the breaker is open.

Lower voltage power works similarly to medium voltage power. Low voltage feeder interlock 172 is shown without low voltage interlock key cylinder and low voltage connection cap so as to highlight how the connection between the low voltage feeder cable and outgoing feeder connection 161 work. Low voltage feeder interlock 172 may also include low voltage multi-pin interlock cable port 174, low voltage cable connection 177, and low voltage indicator lights 176. Mechanical and electrical interlocks may function as described above for medium voltage interlocks.

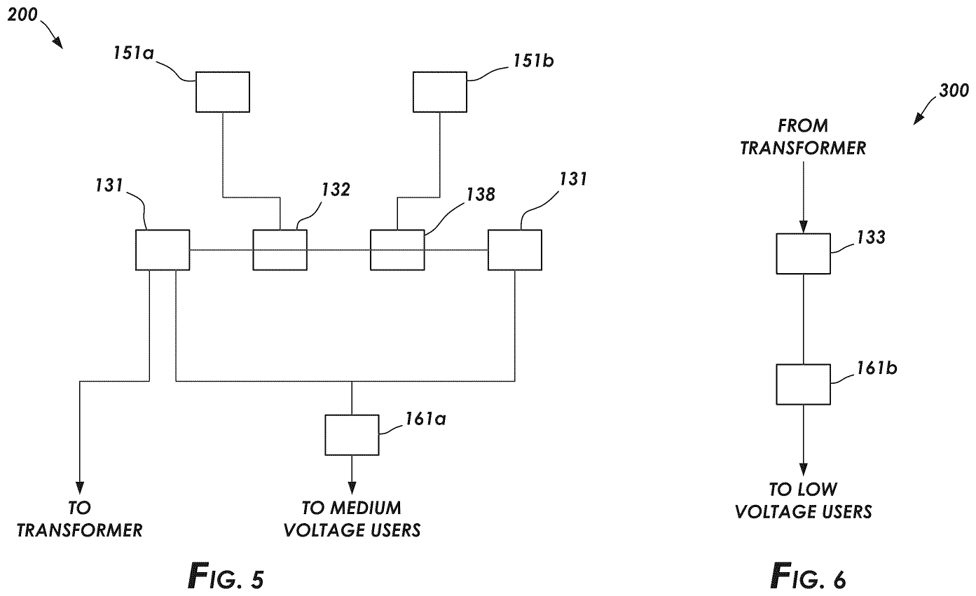

FIG. 5 is a line drawing of the electrical connections of medium voltage electrical system 200. Incoming main power connections 151a and incoming utility power connections 151b may provide a pathway for generator power and utility grid power, respectively, to power mobile multi-voltage power distribution system 100. Incoming main power connections 151a may be electrically connected to main switchgear cabinet 132. Incoming utility power connections 151b may be electrically connected to utility switchgear cabinet 138. As also shown in FIG. 5, main switchgear cabinet 132 and utility switchgear cabinet 138 may be electrically connected to dual stack switchgear cabinets 131. Breakers within dual stack switchgear cabinets 131 may be electrically connected to medium voltage outgoing feeder connections 161a and transformer 121. Medium voltage outgoing feeder connections may be connected to medium voltage power users.

FIG. 6 is a line drawing of the electrical connections of low voltage electrical system 300. 480V power is received from transformer 121 by low voltage switchgear 133. From low voltage switchgear 133, power is transferred to low voltage outgoing feeder connections 161b and therein to low voltage power users.

Thus, mobile multi-voltage power distribution system 100 is a power distribution system that may include a 13.8 kV medium voltage switchgear line up in conjunction with a 13.8 kV to 480V transformer, and a corresponding 480V switchgear lineup that may provide power to multiple types of equipment with varying voltage and amperage input requirements. The ability to support a range of voltages provides significant benefits to support various systems in a rural application. In addition, by being portable, mobile multi-voltage power distribution system 100 may be moved between sites needing power without the construction of additional infrastructure.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A mobile multi-voltage power distribution system comprising:
a skid;
incoming power connections, the incoming power connections in mechanical connection with the skid;
outgoing feeder connections, the outgoing feeder connections in mechanical connection with the skid;
a medium voltage switchgear, the medium voltage switchgear coupled to the skid in electrical connection with the incoming power connections, and at least one of the outgoing feeder connections;
a transformer, the transformer in electrical connection with the medium voltage switchgear and coupled to the skid; and
a low voltage switchgear, the low voltage switcher coupled to the skid and electrically coupled to the transformer and to at least one of the outgoing feeder connections.

2. The mobile multi-voltage power distribution system of claim 1, wherein the incoming power connections are incoming main power connections or incoming utility power connections.

3. The mobile multi-voltage power distribution system of claim 2, wherein the medium voltage switchgear includes a main switchgear cabinet and a utility switchgear cabinet.

4. The mobile multi-voltage power distribution system of claim 3, wherein the incoming main power connections are connected to the main switchgear cabinet and the incoming utility power connections are connected to the utility switchgear cabinet.

5. The mobile multi-voltage power distribution system of claim 1, wherein the medium voltage switchgear further comprises a plurality of dual stack switchgear cabinets.

6. The mobile multi-voltage power distribution system of claim 5, wherein each of the dual stack switchgear cabinets contain two vertically stacked breakers.

7. The mobile multi-voltage power distribution system of claim 6, wherein the main switchgear cabinet, the utility switchgear cabinet, and the dual switchgear cabinets are arranged in a medium switchgear row.

8. The mobile multi-voltage power distribution system of claim 7, wherein the dual switchgear cabinets are positioned on opposite sides of the main switchgear cabinet.

9. The mobile multi-voltage power distribution system of claim 1 wherein, the outgoing feeder connections are in connection with one or more users of electrical power.

10. The mobile multi-voltage power distribution system of claim 1 wherein the medium voltage switchgear includes a dual switchgear cabinet and the transformer is in electrical connection with a breaker from the dual stack switchgear cabinet.

11. The mobile multi-voltage power distribution system of claim 10, wherein the transformer includes a primary winding, a secondary winding, and a third winding.

12. The mobile multi-voltage switchgear of claim 11, wherein secondary winding is adapted to supply power to the low voltage switchgear.

13. The mobile multi-voltage power distribution system of claim 1 further comprising a panel mounted to the skid, the panel adapted to monitor and manage electrical currents, voltages, and frequencies of the transformer, medium voltage switchgear and low voltage switchgear.

14. The mobile multi-voltage power distribution system of claim 1 further comprising a server rack, the server rack in communication with a data van and mounted on the skid.

15. The mobile multi-voltage power distribution system of claim 1, wherein the skid is mounted on a trailer, the trailer having an underside.

16. The mobile multi-voltage power distribution system of claim 15 further comprising a work platform, the work platform positioned on the trailer.

17. The mobile multi-voltage power distribution system of claim 15, wherein the outgoing feeder connections are positioned on the underside of the trailer.

18. The mobile multi-voltage distribution system of claim 17, wherein the outgoing feeder connections are equipped with feeder interlocks.

19. The mobile multi-voltage distribution system of claim 1, wherein the incoming power connections are equipped with interlocks.

20. The mobile multi-voltage distribution system of claim 1 further comprising a battery, the battery mounted on the skid and adapted to provide power for circuit breaker actuation.
